(19) United States
(12) Patent Application Publication
(10) Pub. No.: US 2025/0011520 A1
(43) Pub. Date: Jan. 9, 2025

(54) MULTI-PART LIGNIN-BASED RESIN SYSTEM FOR DECORATIVE LAMINATES

(71) Applicant: WILSONART LLC, Austin, TX (US)

(72) Inventor: Philippe Wloczysiak, Baneuil (FR)

(21) Appl. No.: 18/896,411

(22) Filed: Sep. 25, 2024

Related U.S. Application Data
(63) Continuation of application No. 17/454,428, filed on Nov. 10, 2021, now Pat. No. 12,122,882.
(60) Provisional application No. 63/113,285, filed on Nov. 13, 2020.

(51) Int. Cl. C08G 8/34; B31D 1/00; C08H 7/00

(52) U.S. Cl. CPC C08G 8/34; B31D 1/0075; C08H 6/00

(57) ABSTRACT

A method for making a multi-part resin system includes forming a lignin-formaldehyde resin, forming a phenol-formaldehyde resin, and mixing the lignin-formaldehyde resin and the phenol-formaldehyde to form the multi-part resin system.

### CROSS-REFERENCE TO RELATED APPLICATIONS

This application is a continuation of U.S. patent application Ser. No. 17/454,428, entitled “MULTI-PART LIGNIN-BASED RESIN SYSTEM FOR DECORATIVE LAMINATES,” filed Nov. 10, 2021, which claims the benefit of U.S. Provisional Patent Application Ser. No. 63/113,285, entitled “MULTI-PART LIGNIN-BASED RESIN SYSTEM FOR DECORATIVE LAMINATES,” filed Nov. 13, 2020, both of which are incorporated by reference.

### BACKGROUND OF THE INVENTION

### 1. Field of the Invention

The current invention is related to the production of decorative high pressure laminates built up with a mixture of lignin-formaldehyde resin and phenol-formaldehyde resin, in particular, a resol type phenol-formaldehyde resin. In particular, the invention describes the use, for the treating of kraft paper type which composes the core of the decorative laminates, of a lignin which has been crafted by formaldehyde to create methylol chemical functions leading to a thermosetting resin. This lignin is a phenolic resin type and gives the final product the same properties as a classical resol type phenolic resin.

### 2. Description of the Related Art

High pressure laminates are made of layers of paper treated with thermosetting resins and polymerized with a process combining pressure and temperature as described below. The process of forming high pressure laminates is defined as the simultaneous application of pressure and temperature to allow the flow of the impregnated resins and then the polycondensation of the thermosetting resins leading to a homogeneous and non-porous material whose specific gravity has increased (≥1.35 g/cm³). The top layer(s) that compose(s) the decorative surface has (have) various colors and patterns, and is (are) treated with current melamine resins and/or other kinds of resins (polyurethanes acrylates for example).

The inner layers, also named core layers, are composed of paper treated with phenolic resins, amino plastics resins, or even mixes of phenolic and amino plastics resins. These resins often contain additives that lead to either lower cost resins or special properties, fire rated for example.

For a long time, studies have been conducted on introducing lignin into phenolic resins. R J Seidl, H K Burr, C N Ferguson, G E Mackin (1944), “Properties of laminated plastics made from lignin and lignin-phenolic resin-impregnated papers,” Report no 1595 of States Department of Agriculture, Forest Service, Forest Products Laboratory, Madison, Wisconsin; Frank J Ball, Joseph B Doughty, William G Vardell (1965), “Composition containing resole and lignin in free acid form and process for preparing same,” U.S. Pat. No. 3,185,654 May 25, 1965; David Webster (1965), “Free lignin solutions and method of making and using same,” U.S. Pat. No. 3,216,839 Nov. 9, 1965; Leopold F. Bornstein (1978), “Lignin-based composition board binder comprising a copolymer of a lignosulfonate, melamine and an aldehyde,” U.S. Pat. No. 4,130,515, Dec. 19, 1978. For 20 to 30 years, efforts have doubled and numerous laboratories and/or industries have invested in the valorization and/or the use of this raw material in chemical applications. Clarke at al. (1978), “Methylolated kraft lignin polymer resin,” U.S. Pat. No. 4,113,675 Sep. 12, 1978; J.-S. M. Kazayawoko, B. Riedl, J. Poliquin (1992), “A Lignin-Phenol-Formaldehyde Binder for Particleboard,” International Journal of the Biology, Chemistry, Physics and Technology of Wood, Volume 46 (3), Jan. 1, 1992; Seidel et al. (1984), “Sulfur Containing Lignin Modified Alkaline Earth Treated Phenolic Impregnating Resins For Core Layers of Humidity Resistant Laminates,” U.S. Pat. No. 4,476,193 Oct. 9, 1984; N. S. Cetin, N. Özmen (2002), “Use of Organosolv lignin in phenol-formaldehyde resins for particleboard production I. organosolv lignin modified resins,” International Journal of Adhesion & Adhesives 22 (2002) 477-480; M. Raskin, L. O. Ioffe, A. Z. Pukis, M. H. Wolf (2002), “Resin Material and method of Producing same”, US Patent, 2002/0065400 A1, May 30, 2002; M. V. Alonso, M. Oliet, F. Rodriguez, G. Astarloa, J. M. Echeverria (2004), “Use of a Methylolated Softwood Ammonium Lignosulfonate As Partial Substitute of Phenol in Resol Resins Manufacture,” Journal of Applied Polymer Science, Vol. 94, 643-650 (2004). In 1965, Ball disclosed an adhesive for the manufacture of plywood, fiber board, particle board, and similar products, containing the combination of phenol formaldehyde resin and a lignin derivative, such as lignosulfonates, or alkali lignins. Frank J Ball, Joseph B Doughty, William G Vardell (1965). “Composition containing resole and lignin in free acid form and process for preparing same”, U.S. Pat. No. 3,185,654 May 25, 1965.

This interest is related to the necessity for replacing current raw materials from the petrochemical industry with renewable materials.

### SUMMARY OF THE INVENTION

In one aspect a method for making a multi-part resin system includes forming a lignin-formaldehyde resin, forming a phenol-formaldehyde resin, and mixing the lignin-formaldehyde resin and the phenol-formaldehyde to form the multi-part resin system.

In some embodiments, the phenol-formaldehyde is a resol type phenol-formaldehyde.

In some embodiments, the method includes the step of diluting the multi-part resin system.

In some embodiments, the multi-part resin system is diluted with methanol.

In some embodiments forming the lignin-formaldehyde resin comprises introducing water and heating the water to between 70° C. and 95° C., introducing lignin and mixing with the water for at least 15 minutes at 80° C. to 95° C., introducing an alkali, introducing formaldehyde, and mixing the water, lignin, alkali, and formaldehyde, and maintaining the water, lignin, alkali, and formaldehyde mixture between 70° C. and 95° C.

In some embodiments, the water, lignin, alkali, and formaldehyde mixture is maintained at a temperature between 70° C. and 95° C. for a time between 20 minutes and 180 minutes.

In some embodiments, the alkali is potassium hydroxide KOH 50%.

In some embodiments, the lignin is either in powder form with a solid content of 85% to 95% or in the form of a paste whose solid content is around 50% to 65%.

In some embodiments, mixing includes mixing the phenol-formaldehyde resin and a lignin-formaldehyde resin at between 40° C. and 70° C.

In some embodiments, mixing occurs for at least 60 minutes to have the proper homogenous resin.

In some embodiments, the method further includes adjusting the level of pH in the multi-part resin system.

In some embodiments adjusting the level of pH includes adding para toluene sulfonic.

In some embodiments, the method further includes the step of impregnating a core paper with the multi-part resin system and forming a decorative laminate with the impregnated core paper.

In another aspect, a multi-part resin system includes a lignin-formaldehyde resin and a phenolic resin.

In a further aspect, a method for making a decorative laminate includes preparing a decorative sheet and preparing at least one core layer sheet. Preparing the at least one core layer sheet includes making a multi-part resin system and impregnating the at least one core layer sheet with the multi-part resin system. Making the multi-part resin system includes forming a lignin-formaldehyde resin, forming a phenol-formaldehyde, and mixing the lignin-formaldehyde resin and the phenol-formaldehyde to form the multi-part resin system. The method also includes pressing and heating the decorative sheet and the at least one core layer sheet to form a decorative laminate.

### BRIEF DESCRIPTION OF DRAWINGS

FIGS. 1A and 1B are schematics of decorative laminates in accordance with the present invention wherein FIG. 1A shows a decorative laminate with a single decorative layer positioned on top of the core layer and FIG. 1B shows a decorative laminate with decorative layers applied to both sides of the core layer.

### DETAILED DESCRIPTION OF THE INVENTION

A detailed embodiment is disclosed herein. It should be understood, however, that the disclosed embodiment is merely exemplary of the invention, which may be embodied in various forms. Therefore, the details disclosed herein are not to be interpreted as limiting, but merely as a basis for teaching one skilled in the art how to make and/or use the invention.

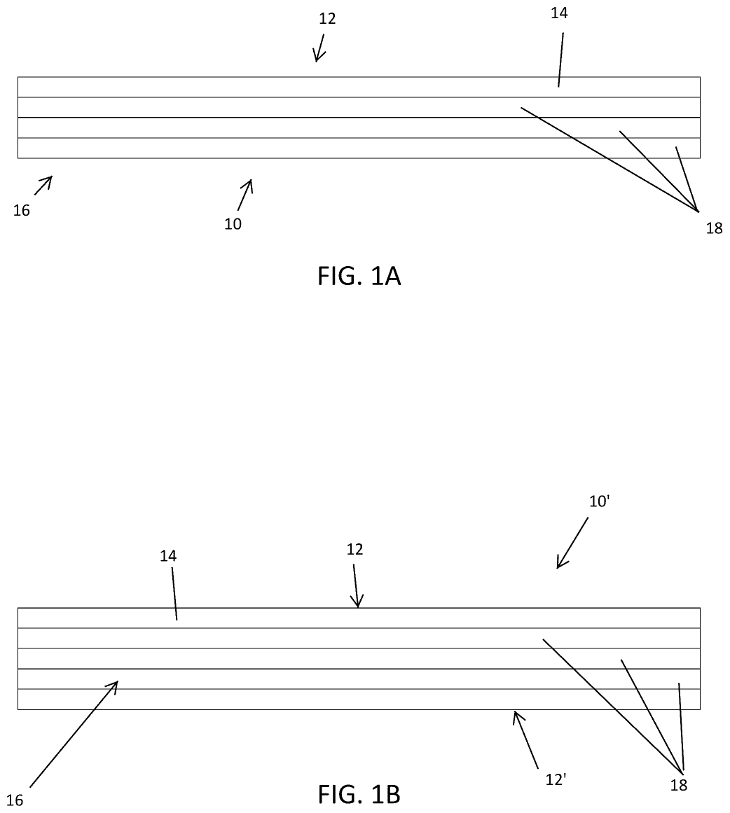

Referring now to the drawings, embodiments of a high pressure decorative laminate are disclosed in FIG. 1A and FIG. 1B. It should be appreciated that similar reference numerals are used in conjunction with the different embodiments to the extent the elements are similar or the same.

Briefly, and as will be described in greater detail below, the decorative laminate 10, 10′ includes a decorative layer 12 and a core layer 16. The decorative layer 12 is composed of a resin impregnated decorative sheet 14 (or dry, unimpregnated decorative with a resin impregnated overlay sheet as discussed below). The core layer 16 is composed of at least one resin impregnated sheet of core paper 18 (sometimes referred to herein as “resin impregnated core sheet”), which is impregnated with a resin composed of the present multi-part resin system composed of a phenol-formaldehyde resin and a lignin-formaldehyde resin. The decorative laminate 10, 10′ is manufactured by preparing the resin impregnated decorative sheet 14 and preparing at least one resin impregnated core sheet 18. Preparing the at least one resin impregnated core sheet 18 includes impregnating the core sheet 18 with a resin composition composed of the present multi-part resin system. The resin impregnated decorative sheet 14 and resin impregnated core sheet 18 are layered to form a laminate lay-up and the laminate lay-up is heated and pressed to consolidate and cure the decorative laminate 10, 10′.

In accordance with some embodiments of the present disclosure, the high pressure decorative laminate may include an overlay paper layer, a decorative layer, and a multi-part resin system core layer. It should be appreciated, however, that the layering pattern may be varied, somewhat, without departing from the spirit of the present disclosure.

The decorative layer 12 is composed of a conventional resin impregnated decorative sheet 14 positioned directly above (and/or below) the core layer 16. The decorative layer 12 is chosen from a wide array of sheets. For example, the decorative layer 12 may be a solid color (for example, white) or may include an aesthetically appealing pattern. Where the decorative layer 12 defines the top surface of the final high pressure laminate, the decorative layer 12 dictates the surface characteristics of the final decorative laminate 10. For example, the composition of the decorative layer 12 dictates the decorative laminate's resistance to chemical agents, heat, light, shock, and abrasion. While a disclosed embodiment presented in FIG. 1A shows a single decorative layer 12 positioned on top of the core layer 16, it is appreciated as shown with reference to FIG. 1B that decorative layers 12, 12′ may be applied to both sides of the core layer 16 to produce a decorative laminate 10′ with a decorative surface on both the top and bottom surfaces. Further, while a decorative layer composed of a single resin impregnated sheet is disclosed herein, it is appreciated the decorative layer may be composed of two or even three sheets.

As discussed above, the decorative layer 12 is composed of a sheet of decorative paper 14. The decorative sheets are commonly manufactured from high quality 60-205 grams/meter2, pigment filled, alpha cellulose paper impregnated with amino plastic resin or/and polyurethane acrylate resin. Although the following disclosure discusses a resin impregnated decorative paper, it is appreciated a dry, unimpregnated decorative paper may be used (so long as a resin impregnated overlay sheet is positioned above the dry, unimpregnated decorative paper, in a manner known in the art, such that the dry, unimpregnated decorative paper is positioned between the overlay sheet and the core layer. The decorative paper 14, in accordance with an embodiment of the present disclosure, is impregnated with a resin content of approximately 0% to 82% (considering 0% accounts for the embodiment described above using a dry, unimpregnated decorative paper in conjunction with an overlay sheet. The resin impregnated decorative sheets 14 are subsequently dried, partially cured, and finally cut into sheets. The pigment filled, alpha cellulose paper of the decorative sheet may include a solid color, a decorative design, or a roto-gravure reproduction of natural materials, such as, wood, marble, leather, etc. The aesthetic characteristics of the cellulose paper are revealed as the laminate's decorative design upon completion of the decorative laminate 10.

The core layer 16 is preferably composed of a plurality of resin impregnated core sheets 18 of what is commonly referred to as “saturating Kraft paper.” While saturating Kraft paper is disclosed herein, it is appreciated, the paper used in the core is not limited to saturating Kraft paper, and papers made from recycled fibers that are suitable for laminates applications are known. For example, Kruger produces a paper made of 100% recycled that is suitable for laminates applications. Further, it is appreciated other paper materials and volume of sheets may be used without departing from the spirit of the present disclosure. In accordance with a disclosed embodiment, the core layer 16 includes two sheets of 160-550 grams/meter2 resin impregnated Kraft paper. The saturating Kraft paper is impregnated with the present multi-part resin system and is partially cured (β-staged). The saturating Kraft paper is impregnated with a resin content of approximately 28% to 46%.

It is known that current phenol-formaldehyde resin with a molar ratio F (formaldehyde)/P (phenol)>1.5 allows the growth of a 3-dimensional network. For its part, the lignin does not have methylol (hydroxymethyl) function that can allow a 3-dimensional continuous network chemically bonded. Furthermore, in view of the size of the molecular weight of the oligomer chains, the steric hindrance limits the access of large molecules to reactive sites of aromatic cycles in the lignin. As these resins are designed to treat papers, the high molecular weight must be managed. Indeed, if it is quite easy to adjust the molecular weight for the current phenol-formaldehyde resin in order to treat the current papers, it is far more complicated with lignin.

As part of prior phenolic glue studies between 2014 and 2017, the lignin was studied as a reactant in a mix with phenol and formaldehyde. J.-S. M. Kazayawoko, B. Riedl, J. Poliquin (1992), “A Lignin-Phenol-Formaldehyde Binder for Particleboard,” International Journal of the Biology, Chemistry, Physics and Technology of Wood, Volume 46 (3), Jan. 1, 1992; Areskogh et al. (2018), “An Activated Lignin Composition, A Method for the Manufacturing Thereof and Use Thereof,” US Patent, 2018/0086916 A1, Mar. 29, 2018; D. Areskogh (2017), “A Method for Increasing the Reactivity of Lignin, A Resin Composition Comprising said Lignin and Use of said Resin Composition,” 12 Jan. 2017 WO 2017/006215 A1. In the case of phenolic resins for high pressure laminates, thus for treating of paper, the present invention addresses the incorporation of lignins differently, and the strategy of the present invention focuses on considering lignin as a resin on its own right. This approach allowed for the present invention to not only simplify the total operations (steps), but also to easily adjust viscosities and reactivities.

Thus, the present multi-part resin system does not have a lignin-phenol-formaldehyde resin but two resins, one phenol-formaldehyde resin and one lignin-formaldehyde resin. In fact, in the literature, two methods are presented to easily activate: the phenolation [N. S. Cetin, N. Özmen (2002), “Use of Organosolv lignin in phenol-formaldehyde resins for particleboard production I. organosolv lignin modified resins,” International Journal of Adhesion & Adhesives 22 (2002) 477-480; M. Raskin, L. O. Ioffe, A. Z. Pukis, M. H. Wolf (2002), “Resin Material and method of Producing same,” US Patent, 2002/0065400 A1, May 30, 2002; Pietarinen et al. (2019), “Method for Treating Lignin and for Producing a Binder Composition,” U.S. Pat. No. 10,301,437 B2, Mar. 28, 2019; Pietarinen (2015), “A Method for Treating Lignin and for Producing a Binder Composition,” WO 2015/079107 A1 4 Jun. 2015; L. Hu, H. Pan, Y. Zhou, M. Zhang (2011), “Methods to Improve Lignin's Reactivity as a Phenol Substitute and as Replacement for Other Phenolic Compounds: A Brief Review,” BioRessources 6 (3), 3515-3525] and the methylolation [Studies on Lignin-Based Adhesives for Particleboard Panels, Turk J Agric For 27 (2003) 183-189 @ TÜB<TAK; P. Dilling (1988), “Method for Methylolation of Lignin Material,” U.S. Pat. No. 4,764,597A Aug. 16, 1988; W. Peng, B. Riedl, A. O. Barry (1993), “Study on the kinetics of lignin methylolation,” Journal of Applied Polymer Science Vol. 48, Issue 10, 1757-1763]. And all works published and patented recently start with one of the two operations and then add either phenol or formaldehyde to complete the resin. M. Ghorbani, A. R. Mahendran, H. W. G. van Herwijnen, F. Liebner, J. Konnerth (2018), “Paper-based laminates produced with kraft lignin-rich phenol-formaldehyde resoles meet requirements for outdoor usage,” European Journal of Wood and Wood Products 76, 481-487; Pietarinen (2013), “A Method for Increasing the Reactivity of Lignin,” WO 2013/144454 A1, 3 Oct. 2013; M. Wang, M. Leitch, C (Charles) Xu (2009), “Synthesis of phenol-formaldehyde resol resins using organosolv pine lignins,” European Polymer Journal 45, 3380-3388; Jobber A. S, Ferrari L., Helwegen K. M. F. (2018), “A method for preparing an activated lignin composition,” WO 2018/190720 A1, 18 Oct. 2018; N. S. Cetin, N. Özmen (2002), “Use of Organosolv lignin in phenol-formaldehyde resins for particleboard production I. organosolv lignin modified resins,” International Journal of Adhesion & Adhesives 22. (2002) 477-480.

The present invention goes in a different direction by considering lignin as a reactant or an oligomer that only needs additional methylol functions to enhance the growth of a three-dimensional network chemically bonded.

The present multi-part resin system is prepared with:
A Lignin-Formaldehyde like a resin,
   In alkali conditions
A phenolic resin employing current known procedures
   That way it is easy to adjust the final characteristics of the resin playing on
      The characteristics of the phenolic resin
         E.g., Formaldehyde/Phenol ratio (for example, 1.3 to 2.5), level of condensation, etc.
      The characteristics of lignin-based resin
         E.g., Formaldehyde/Lignin ratio, Time, Temperature, pH, etc.,
      The ratio of Lignin-Formaldehyde Resin/Phenolic Resin
      The dilution with solvent.

As briefly discussed above, the multi-part resin system of the present invention is used to impregnate the sheets making up the core layer. In particular, the multi-part resin system includes a mix of a resol type phenol-formaldehyde and a lignin-formaldehyde resin.

The multi-part resin system is prepared by blending a resol type phenol-formaldehyde resin resol type commonly used in the laminate industry and a lignin-formaldehyde resin. The multi-part resin system is ultimately diluted with methanol and the quantity of methanol depends on the paper being treated.

The lignin-formaldehyde resin is prepared in the following manner:
Introducing water and heat up between 70° C. and 95° C.
Introducing lignin and mix for at least 15 minutes at 80° C. to 95° C.
Introducing an alkali, like potassium hydroxide KOH 50%.
Introducing Formaldehyde.
Maintaining the mixing between 70° C. and 95° C. for a time between 20 minutes and 180 minutes.

In accordance with a disclosed embodiment, the lignin is either in powder form with a solid content of 85% to 95% or in the form of a paste whose solid content is around 50% to 65%. While temperature and time parameters are disclosed above, it is appreciated other temperature and time parameters may be used without departing from the spirit of the invention.

Once the phenol-formaldehyde resin and a lignin-formaldehyde resin are prepared, the phenol-formaldehyde resin and a lignin-formaldehyde resin are mixed together at a temperature between 40° C. and 70° C. for at least 60 minutes to have the proper homogenous resin. In accordance with a disclosed embodiment, the lignin-formaldehyde resin and the phenol-formaldehyde resin are mixed at a ratio of 30/70 or 50/50. The operation is completed with a dilution with methanol and/or water to make the resin suitable for the treating of the papers. The level of dilution and the dilution composition depend on lignin/Phenol ratio and kind of paper. By way of example, a paper is impregnated using a double coater treater, wherein the viscosity is approximately 50 cps at 25° C. (solid around 40%). However, the same paper, and deep and squeeze roll treater, the viscosity is set at approximately 70 cps (solid around 45%). With other papers it has been found that a viscosity of 20 cps is acceptable with methanol dilution and resin impregnation with deep and squeeze rolls treater, but it is also possible to achieve similar results with water dilution and impregnation with a double coater system.

In addition, the level of pH and acid are adjusted to control the pH (between 8.5 and 9.5) depending on the ratio Base/Lignin. The best acid is Para toluene sulfonic acid, but other organic ones could be possible)

The multi-part resin may then be applied to the saturating Kraft paper and the polymerization of the composite is completed with the simultaneous application of heat and high pressure which characteristics are the following ones:

Once the appropriate layers of the laminate are formed, the sheets 14, 18 are stacked in a conventional manner, and the laminate lay-up is heated and pressed. In accordance with an embodiment of the present disclosure, the layers are first stacked and placed between steel plates. The laminate stack is then subjected to temperatures in the range of 130° C. to 160° C., and pressure of about 20 kg/cm2 to 100 kg/cm2 for a time sufficient to consolidate the laminate and cure the resins (generally about 20 minutes to 60 minutes). The pressure and heat force the resin in the paper sheets to flow, cure and consolidate the sheets into a unitary laminated mass referred to in the art as a decorative high pressure laminate. Generally, more than one laminate is formed at one time. Multiple laminates are formed by inserting a plurality of assembled sheets in a stack. Release sheets are positioned between the assembled sheets to separate the various laminates stacked together. After consolidation, the release sheets allow the individual laminates to be separated.

The laminate is then cooled for approximately 10 minutes under pressure before it is ready for further processing in preparation for its use in the manufacture of various products. During this last operation, the surface is in contact with a plate or a release paper that gives the material the final texture.

The resulting high pressure laminate meets the standard EN 438. The high pressure laminate of the present invention also allows a dramatic reduction in phenol needed for the production of the decorative high pressure laminates. In addition, the free phenol of such resins is very low.

While specific temperatures, pressures, and times are described above, it should be appreciated that a variety of pressing techniques may be used without departing from the spirit of the present disclosure.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method for making a multi-part resin system, comprising:
forming a lignin-formaldehyde resin;
forming a phenol-formaldehyde resin;
mixing the lignin-formaldehyde resin and the phenol-formaldehyde resin to form the multi-part resin system.

2. The method according to claim 1, wherein the phenol-formaldehyde resin is a resol type phenol-formaldehyde.

3. The method according to claim 1, further including the step of diluting the multi-part resin system.

4. The method according to claim 1, wherein forming the lignin-formaldehyde resin comprises introducing water and heating the water to between 70° C. and 95° C.; introducing lignin and mixing with the water for at least 15 minutes at 80° C. to 95° C.; introducing an alkali; introducing formaldehyde; and mixing the water, lignin, alkali, and formaldehyde and maintaining the water, lignin, alkali, and formaldehyde mixture between 70° C. and 95° C.

5. The method according to claim 4, wherein the water, lignin, alkali, and formaldehyde mixture is maintained at a temperature between 70° C. and 95° C. for a time between 20 minutes and 180 minutes.

6. The method according to claim 1, wherein the lignin is either in powder form with a solid content of 85% to 95% or in the form of a paste whose solid content is around 50% to 65%.

7. The method according to claim 1, wherein mixing includes mixing the phenol-formaldehyde resin and a lignin-formaldehyde resin at around 40° C. to 70° C.

8. The method according to claim 1, further including adjusting a pH in the multi-part resin system.

9. The method according to claim 1, further including the step of impregnating a core paper with the multi-part resin system and forming a decorative laminate with the impregnated core paper.

10. A multi-part resin system, comprising:
a lignin-formaldehyde resin; and
a phenolic resin.

11. The multi-part resin system according to claim 10, wherein the lignin-formaldehyde resin is formed under alkali conditions.

12. A method for making a decorative laminate, comprising:
preparing a decorative sheet;
preparing at least one core layer sheet, wherein preparing the at least one core layer sheet includes making a multi-part resin system and impregnating the at least one core layer sheet with the multi-part resin system, wherein making the multi-part resin system includes forming a lignin-formaldehyde resin; forming a phenol-formaldehyde; and mixing the lignin-formaldehyde resin and the phenol-formaldehyde to form the multi-part resin system;
pressing and heating the decorative sheet and the at least one core layer sheet to form a decorative laminate.

13. The method according to claim 12, wherein the phenol-formaldehyde resin is a resol type phenol-formaldehyde resin.

14. The method according to claim 12, further including the step of diluting the multi-part resin system.

15. The method according to claim 12, wherein forming the lignin-formaldehyde resin comprises introducing water and heating the water to between 70° C. and 95° C.; introducing lignin and mixing with the water for at least 15 minutes at 80° C. to 95° C.; introducing an alkali; introducing formaldehyde; and mixing the water, lignin, alkali, and formaldehyde and maintaining the water, lignin, alkali, and formaldehyde mixture between 70° C. and 95° C.

16. The method according to claim 15, wherein the water, lignin, alkali, and formaldehyde mixture is maintained at a temperature between 70° C. and 95° C. for a time between 20 minutes and 180 minutes.

17. The method according to claim 12, wherein the lignin is either in powder form with a solid of 85-95% or in the form of a paste whose solid is around 50% to 65%.

18. The method according to claim 12, wherein mixing includes mixing the phenol-formaldehyde resin and a lignin-formaldehyde resin at around 40° C. to 70° C.

19. The method according to claim 12, further including adjusting a pH in the multi-part resin system.

20. The method according to claim 12, further including the step of impregnating a core paper with the multi-part resin system and forming a decorative laminate with the impregnated core paper.
